(19) United States
(12) Patent Application Publication
(10) Pub. No.: US 2008/0292326 A1
(43) Pub. Date: Nov. 27, 2008

(54) Optical Voltage Controlled Oscillator for an Optical Phase Locked Loop

(76) Inventors: Valter Ferrero, Rivalta Di Torino (IT); Roberto Gaudino, Torino (IT)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/630,178

(22) PCT Filed: Sep. 15, 2004
(86) PCT No.: PCT/EP04/52186

§ 371 Date: Apr. 8, 2008

(30) Foreign Application Priority Data
Sep. 16, 2003 (IT) TO2003A000708

(51) Int. Cl. H04B 10/148

(52) U.S. Cl. 398/213

(57) ABSTRACT

An optical phase locked loop (1), comprising an optical phase detector (2) receiving as inputs an optical signal to be locked (symbol I) and a locked optical signal (symbol II) and providing as its output an electrical error signal (V_{PD}) indicating the phase shift existing between the optical signal to be locked (symbol I) and the locked optical signal (symbol II); an electrical loop filter (3) receiving the electrical error signal (V_{PD}) and outputting a filtered electrical error signal (V_{PDF}), and an optical voltage controlled oscillator (4) receiving as an input the filtered electrical error signal (V_{PDF}) and outputting the locked optical signal (symbol II). The optical voltage controlled oscillator (4) comprises an electrical voltage controlled oscillator (8) receiving as an input the filtered electrical error signal (V_{PDF}) and outputting a modulating electrical signal (V_{EVCO}), an external-cavity semiconductor laser source (9) providing an optical carrier (S_{OC}), and a Mach-Zehnder optical amplitude modulator (10) receiving as an input the optical carrier (S_{OC}) and the modulating electrical signal (V_{EVCO}) and outputting the locked optical signal (symbol II), which is obtained by amplitude modulating the optical carrier (S_{OC}) with the modulating electrical signal (V_{EVCO}).

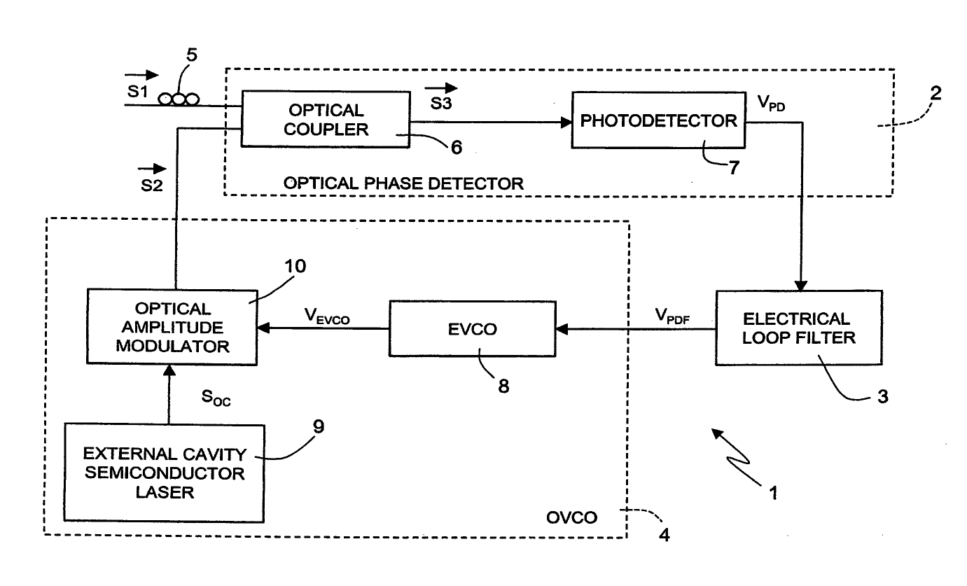

### TECHNICAL FIELD

The present invention relates to an optical voltage controlled oscillator for an optical phase lock loop.

### BACKGROUND ART

Optical Phase Locked Loops (OPLL) are optical devices used in frequency synthesis and in coherent demodulation in optical communication systems to generate locally an optical signal whose frequency and phase track those of an input optical signal.

In particular, an OPLL is essentially constituted by an optical phase detector, by an electrical loop filter, and by an optical voltage controlled oscillator (OVCO).

In particular, the phase detector receives as an input an optical signal to be locked and a locked optical signal, i.e. one whose frequency and phase are “locked” to those of the input optical signal, provided by the OVCO, and outputs an electrical error signal indicating the phase difference existing between the input optical signals.

The electrical error signal generated by the phase detector 2 is sent to the loop filter, which has a low pass transfer function and outputs a filtered electrical error signal provided as an input to the OVCO, which outputs the aforementioned locked optical signal, whose instantaneous frequency varies proportionally with the amplitude of the filtered electrical signal.

OVCOs are generally manufactured by using solid state tuneable lasers or directly modulable semiconductor lasers, which, though used in the past, have some drawbacks which have a considerable impact on the use of the OPLLs in which they are inserted.

In particular, while they have undoubted strengths in terms of spectral efficiency and functionality (insensitivity to non-linear effects) deriving from the reduced line width of solid state lasers, OPLLs using OVCOs based on solid state lasers are nonetheless difficult to apply to optical communication systems because it is quite difficult to find solid state lasers operating in the frequency grid set by the ITU (International Telecommunication Union), they are very voluminous and bulky, they require a great deal of power for their operation, and are considerably more expensive than OPLLs using OVCOs based on semiconductor lasers.

However, although the latter are considerably less costly than OPLLs using solid state laser based OVCOs, they require the use of a Distributed Feed-Back (DFB) technology, which in turn requires using broadband feedback electronic circuits, because of the considerable line width of directly controlled semiconductor lasers and an extremely high injection current due to the non ideal operation of these devices.

The constant market demand for ever higher data transmission speeds will cause the high spectral efficiency and the insensitivity to non linear effects of OPLLs to be an essential factor in next-generation optical communication systems.

If one observes the ongoing evolution in current transmission systems, it is readily apparent that the performance of standard intensity modulation and direct detection (IM-DD) transmission systems based on the “Not Return to Zero” (NRZ) or “Return to Zero” (RZ) formats is approaching ever more closely its theoretical limits in terms of spectral efficiency and insensitivity to non linear effects.

For these reasons, to enhance the performance of optical communication systems, the only solution currently available would be a significant change in the structure of the transmission system, for example using, in transmission, phase, frequency, amplitude modulations and any combination thereof, such as PSK (Phase Shift Keying), FSK (Frequency Shift Keying), QAM (Quadrature Amplitude Modulation), etc., and, in reception, a coherent homodyne detection.

By way of example, a binary PSK transmission system with homodyne coherent detection has a sensitivity that is better by 3.5 dB than that of a standard IM-DD transmission system with NRZ format. This advantage can be used to reduce by about 3.5 dB the average transmitted optical power required for each transmission channel. In terms of peak power, therefore, a reduction of about 6.5 dB is obtained, which drastically reduces fibre non-linear effects, a source of performance degradation.

As an additional example, the spectral occupation of a 4-PSK transmission system is halved with respect to a standard binary transmission system with NRZ format.

### DISCLOSURE OF INVENTION

The object of the present invention is to provide an OVCO for an OPLL which allows at least partially to overcome the drawbacks of the traditional OPLLs described above.

According to the present invention, an electrically controlled optical oscillator, as defined in claim 1, is provided.

According to the present invention, moreover, an optical phase locked loop, as defined in claim 8, is also provided.

### BRIEF DESCRIPTION OF THE DRAWING

For a better understanding of the present invention, a preferred embodiment thereof shall now be described, purely by way of non limiting example and with reference to the accompanying FIGURE, which shows a block diagram of an optical phase locked loop according to the invention.

### BEST MODE FOR CARRYING OUT THE INVENTION

In particular, in the accompanying FIGURE the reference number 1 globally designates an OPLL according to the invention, which essentially comprises an optical phase detector 2, an electrical loop filter 3, an OVCO 4 and an optical polarization controller 5.

The optical phase detector 2 comprises an optical coupler 6 receiving as inputs an optical signal to be locked \vec{S}₁ and a locked optical signal \vec{S}₂ provided by the OVCO 4 and outputting a coupled optical signal \vec{S}₃.

In particular, assuming to be working, for the sake of simplicity, on monochromatic signals, and indicating with:

\vec{S}₁=S₁·e^{j(ω}^{₁}^{t+φ}^{₁}⁾·ŝ₁

\vec{S}₂=S₂·e^{j(ω}^{₂}^{t+φ}^{₂}⁾·Ŝ₂

where:

S₁, S₂: are the amplitudes of the electromagnetic fields \vec{S}₁ and \vec{S}₂

ω₁, ω₂: are the optical angul Lr frequencies of \vec{S}₁ and \vec{S}₂

φ₁, φ₂: are the optical phases of \vec{S}₁ and \vec{S}₂

ŝ₁, ŝ₂: are the optical polarizations of \vec{S}₁ and \vec{S}₂

the coupled optical signal \vec{S}₃ out ut by the optical coupler 6 can be represented by the following general expression:

\vec{S}₃=\vec{S}₁′+\vec{S}₂′=k₁·S₁·ŝ₁′·e^{j(ω}^{₂}^{t+φ}^{₂}^{+φ}^{₁}^{′)}

wherein:

ŝ₁′=ŝ₁·M₁

ŝ₂′=ŝ₂·M₂

and where:
k₁, k₂: are attenuation factors of the amplitudes of the electromagnetic fields Ŝ₁ and Ŝ₂, introduced by the optical coupler,
φ₁′, φ₂′: are phase shifts introduced by the optical coupler,
ŝ₁′, ŝ₂′: are the optical polarizations of \vec{S}₁ and \vec{S}₂ at the output of the optical coupler,
M₁, M₂: are the polarization rotation matrices (2×2) on \vec{S}₁ and \vec{S}₂ accounting for the coupler 6 polarization effects

An example of optical coupler 6 can be represented by an ideal 3 dB coupler, where:

$${ϕ}_{1}^{′} = 0 ° ; {ϕ}_{2}^{′} = 90 ° ; {k}_{1} = {k}_{2} = 1 / \sqrt{2} , \\ {M}_{1} = {M}_{2} = [ \begin{matrix}1 & 0 \\ 0 & 1\end{matrix} ]$$

Besides standard 2×1 or 2×2 optical couplers, an additional example of optical coupler 6 can be represented by an ideal 90° hybrid coupler, which is a 2×2 optical device having two optical outputs providing, respectively, an optical signal \vec{S}₃ and an optical signal \vec{S}₄ whose general expressions are the following:

\vec{S}₃=\vec{S}₁′ₒᵤₜ₁+S₂′ₒᵤₜ₁k₁_{ₒᵤₜ₁}·S₁·ŝ₁′ₒᵤₜ₁·e^{j(ω}^{₁}^{t+φ}^{₁}^{+φ}^{₁}^{′}^{ₒᵤₜ₁}⁾+k₂_{_{—}}ₒᵤₜ₁·S₂ŝ₂′ₒᵤₜ₁·e^{j(ω}^{₂}^{t+φ}_{₂}^{+φ}_{₂}^{′}_{ₒᵤₜ₁}⁾

\vec{S}₄=\vec{S}₁′ₒᵤₜ₂+S₂′ₒᵤₜ₂k₁_{ₒᵤₜ₂}·S₁·ŝ₁′ₒᵤₜ₂·e^{j(ω}^{₁}^{t+φ}^{₁}^{+φ}^{₁}^{′}^{ₒᵤₜ₂}⁾+k₂_{_{—}}ₒᵤₜ₂·S₂ŝ₂′ₒᵤₜ₂·e^{j(ω}^{₂}^{t+φ}_{₂}^{+φ}_{₂}^{′}_{ₒᵤₜ₂}⁾

wherein:

$${ϕ}_{{2}^{′} out 1} = {ϕ}_{{1}^{′} out 1} ;$$

$${k}_{1 \_out1} = {k}_{2 \_out1} = 1 / \sqrt{2} , \\ {M}_{1 \_out1} = {M}_{2 \_out1} = [ \begin{matrix}1 & 0 \\ 0 & 1\end{matrix} ]$$

$${ϕ}_{{2}^{′} out 2} = {ϕ}_{{1}^{′} out 2} + 90 ° ;$$

$${k}_{1 \_out2} = {k}_{2 \_out2} = 1 / \sqrt{2} , \\ {M}_{1 \_out2} = {M}_{2 \_out2} = [ \begin{matrix}1 & 0 \\ 0 & 1\end{matrix} ]$$

and where:
k₁_{_{—}}ₒᵤₜ₁, k₂_{_{—}}ₒᵤₜ₁: are attenuation factors of the amplitudes of the electromagnetic fields \vec{S}₁ and \vec{S}₂, introduced at the first output by the optical coupler,
k₁_{_{—}}ₒᵤₜ₂, k₂_{_{—}}ₒᵤₜ₂: are attenuation factors of the amplitudes of the electromagnetic fields \vec{S}₁ and \vec{S}₂ introduced at the second output by the optical coupler,
φ₁′ₒᵤₜ₁, φ₂′ₒᵤₜ₁: are phase shifts introduced at the first output by the optical coupler,
φ₁′ₒᵤₜ₂, φ₂′ₒᵤₜ₂: are phase shifts introduced at the second output by the optical coupler,
ŝ₁′ₒᵤₜ₁, ŝ₂′ₒᵤₜ₁: are optical polarizations of \vec{S}₁ and \vec{S}₂ at the first output of the optical coupler, ŝ₁′ₒᵤₜ₂, ŝ₂′ₒᵤₜ₂: are optical polarizations of \vec{S}₁ and \vec{S}₂ at the second output of the optical coupler,
M₁_{_{—}}ₒᵤₜ₁, M₂_{_{—}}ₒᵤₜ₁: are rotation matrices (2×2) of the optical polarizations of \vec{S}₁ and \vec{S}_{2 at the first output of the optical coupler, and}
M₁_{_{—}}ₒᵤₜ₂, M₂_{_{—}}ₒᵤₜ₂: are rotation matrices (2×2) of the optical polarizations of \vec{S}₁ and \vec{S}₂ at the second output of the optical coupler.

The phase detector 2 further comprises a photodetector 7 receiving as an input the coupled optical signal \vec{S}₃ generated by the optical coupler 6 and outputting an electrical voltage error signal V_{PD} indicating the phase difference existing between the optical signal to be locked \vec{S}₁ and the locked optical signal \vec{S}₂.

The electrical error signal is then provided as an input to the electrical loop filter 3, which is a low-pass filter of the kind commonly used in electrical phase locked loops and outputs a filtered electrical error signal V_{PDF}.

The filtered electrical error signal V_{PDF} is then provided as an input to the OVCO 4, which outputs the aforementioned locked optical signal \vec{S}₂, whose frequency varies proportionately with the amplitude of the filtered electrical error signal V_{PDF}.

The polarization controller 5 is positioned at the input of the optical coupler 6 at which the optical signal to be locked is received and it modifies, in a manner that is known in itself and hence not described in detail herein, the optical polarization of the optical signal to be locked in such a way that the optical polarizations of the optical signal to be locked and of the locked optical signal are parallel to each other at the input of the photodetector 7.

According to an aspect of the present invention, the OVCO 4 essentially comprises an electrical voltage controlled oscillator 8 (EVCO), a continuous wave laser source 9, and a Mach-Zehnder optical amplitude modulator 10.

The EVCO 8 is an oscillator whose free oscillation frequency is definable during the design phase and whose output is constituted by a sinusoidal signal whose frequency deviation relative to the free oscillation frequency is proportional to the amplitude of the electrical signal provided at its input. In the specific case, the EVCO 8 receives as an input the filtered electrical error signal V_{PDF} provided by the electrical loop filter 3 and outputs a modulating electrical signal V_{EVCO} constituted by a sinusoidal voltage whose frequency is a function of the amplitude of the filtered electrical error signal V_{PDF}.

The continuous wave laser source 9 is constituted by an external cavity semiconductor laser source of the kind commonly available on the market and built with DFB technology typical for DWDM applications and generating an optical carrier S_{OC}, i.e. a nearly monochromatic optical signal, having an optical electromagnetic field with “almost ideally” sinusoidal profile, and adjustable optical frequency.

The Mach-Zehnder optical modulator 10 receives, at an optical input, the optical carrier S_{OC} generated by the laser source 9 and, at an electrical input, the (sinusoidal) modulating electrical signal V_{EVCO} generated by the EVCO 8 (which may be amplified by a driver for optical modulators) and provides at an optical output the aforementioned locked optical signal \vec{S}₂, whose phase and frequency are a function of the modulating electrical signal V_{EVCO} generated by the EVCO 8 for the reasons that will be described hereafter.

The operation of the OPLL 1 shall be described below, starting from the operation of the OVCO 4 and taking as met the following operating conditions of the OVCO 4 itself:

a) the operating point at rest (i.e. in the absence of a modulating signal) of the Mach-Zehnder modulator 10 is positioned on one of the minimums of the electro-optical transfer function F(V) (defined as the ratio of the output optical power and the input applied voltage) of the modulator, which, as is well known, ideally has a squared cosine periodic profile as a function of the applied voltage V, variable between a maximum value and a minimum value which is typically close to zero); as shall become more readily apparent hereafter, this allows the OVCO 4 to operate in a so-called suppressed carrier and sub carrier generation mode thanks to the sinusoidal modulating signal output by the EVCO 8 (Sub Carrier Optical Phase Locked Loop-SC-OPLL);

b) the Extinction Ratio ER of the Mach-Zehnder modulator 10 should be sufficiently high (such as ER >15 dB); said extinction ratio ER is defined as:

$$ER = 10 {log}_{10} \frac{max [ F ( V ) ]}{min [ F ( V ) ] }$$

c) the amplitude of the modulating electrical signal V_{EVCO} provided to the Mach-Zehnder modulator 10 is no greater than the voltage Vπ, defined as the difference in applied voltage V at the Mach-Zehnder modulator between a maximum point and a minimum point of the electro-optical transfer function F(V) of the modulator itself.

Designating as F_{LASER} the optical frequency of the optical carrier S_{OC} generated by the laser source 9 and as F_{EVCO} the electrical frequency of the modulating electrical signal V_{EVCO} generated by the EVCO 8, the power spectrum of the output signal of the Mach-Zehnder modulator 10 contains:
two main spectral lines at the frequencies F_{LASER}−F_{EVCO} and F_{LASER}+F_{EVCO} (sub carriers);
a spurious spectral line at the frequency F_{LASER} attenuated relative to the two main spectral lines of a factor determined mainly by the extinction ratio of the modulator;
additional spurious spectral lines at the frequencies F_{LASER}−n·F_{EVCO} and F_{LASER}+n-F_{EVCO}, where n is an integer greater than one.

In this way, at the output of the Mach-Zehnder modulator 10, an optical signal is obtained having the main spectral lines (sub carrier) whose optical frequencies and phases are proportional to the electrical driving signal of the EVCO 8, whence the previously mentioned name of optical voltage controlled oscillator with suppressed carrier and sub-carrier generation.

Based on the above description, it is readily apparent that the present invention allows to obtain, using components that are commonly available on the market, an OVCO 4 having the same functionality as a traditional OVCO manufactured by using tuneable solid state or semiconductor lasers. The optical signal \vec{S}₂ provided by the OVCO 4 has an optical spectrum constituted by two main spectral lines (sub carriers), whose frequencies and phases are directly controlled by the filtered electrical error signal V_{PDF} input to the OVCO 4, which input coincides with that of the EVCO 8.

The operation of the OPLL 1 as a whole is instead wholly identical to that of a traditional OPLL obtained using a traditional OVCO obtained with tuneable solid state or semiconductor lasers.

Assuming that one of the two main spectral lines of the optical signal \vec{S}₂ (hereafter called, for the sake of convenience, locked line) is selected (i.e. by using an optical filter), the difference between the phase of the optical signal \vec{S}₁ and the phase of the locked line of the optical signal \vec{S}₂ provided by the phase detector 2 represents an error signal used to control the EVCO 8, which outputs a sinusoidal voltage V_{EVCO} whose frequency is proportional to that error.

Therefore, thanks to the fact that the phase of the locked line of the optical signal \vec{S}₂ corresponds to that of one of the two main spectral lines in the optical power spectrum output by the Mach-Zehnder modulator 10, and since the latter is a function of the frequency F_{EVCO} of the sinusoidal signal V_{EVCO} output by the EVCO 8, the operating state of the OPLL 1 will evolve in such a way as to cancel out the phase error existing between the optical signal \vec{S}₁ and the locked line of the optical signal \vec{S}₂.

Assuming to use as the locked line the second main spectral line (F_{LASER}+F_{EVCO}) of the output power spectrum of the Mach-Zehnder modulator 10 and to use an EVCO 8 in which the sinusoidal output voltage frequency is proportional to the control signal provided at its input, then if the frequency (or the phase) of the optical signal \vec{S}₁ tends to increase, the difference between the frequency (or the phase) of the optical signal \vec{S}₁ and the frequency (or the phase) of the locked line (F_{LASER}+F_{EVCO}) of the optical signal \vec{S}₂ would also tend to increase, and hence the amplitude of the control signal of the EVCO 8 would tend to increase as well, thereby causing an increase in the frequency F_{EVCO} of the sinusoidal voltage V_{EVCO} output by the EVCO 8, thus contrasting the increase in the difference in frequency (or in phase) between the optical signal \vec{S}₁ and the frequency (or the phase) of the locked line (F_{LASER}+F_{EVCO}) of the optical signal \vec{S}₂.

Obviously, similar considerations can be made if the locked line is the first main spectral line (F_{LASER}−F_{EVCO}) of the output power spectrum of the Mach-Zehnder modulator 10.

According to a further aspect of the present invention, the choice of which of the two main spectral lines of the output power spectrum of the Mach-Zehnder modulator 10 is to be used as the locked line can be made by adjusting the optical frequency F_{LASER} of the optical carrier S_{OC} provided by the external cavity semiconductor laser 9, in such a way that the frequency of the locked line is as close as possible to the frequency F_{INPUT} of the optical signal \vec{S}₁, i.e. is within the locking band of the OPLL 1.

Supposing for example that the frequency F_{LASER} is close to the frequency F_{LASER}+F_{EVCO} of the second main spectral line of the output power spectrum of the Mach-Zehnder modulator 10, after the coupling of the optical signal \vec{S}₁ and of the optical signal \vec{S}₂ as generated by the Mach-Zehnder modulator 10, i.e. composed of the spectral lines at the frequencies F_{LASER}, F_{LASER}−n·F_{EVCO} and F_{LASER}+n·F_{EVCO} (n≧1), the beat, introduced by the photodetection, between the frequency of the optical signal \vec{S}₁, i.e. F_{INPUT}, and the three main frequencies of the spectrum of the optical signal \vec{S}₂, i.e. F_{LASER}, F_{LASER}−F_{EVCO} and F_{LASER}+F_{EVCO}, will generate a series of spectral lines at different frequencies in which there will be a base band spectral line (exactly at 0 Hz if OPLL 1 is locked) and other spurious spectral lines at frequencies ±n·F_{EVCO}. By appropriately designing the electrical loop filter 3, these spurious spectral lines will be eliminated thanks to its filtering and possibly also thanks to the filtering introduced by the photodetector 7.

After the filtering introduced by the electrical loop filter 3, therefore, only the beat between the main spectral line selected as the locked line and the signal to be locked will remain in the bandbase; this beat represents the filtered electrical error signal V_{PDF} used to drive the EVCO 8.

The main advantages of the SC-OPLL according to the invention are the following:
Use of an external optical modulator and of an EVCO allows to achieve extremely high accuracy in the synthesis of the optical frequency, to the point that it is limited only by the characteristics of the EVCO. Currently, commercial EVCOs are available even with very high frequencies (50-60 GHz) and a relatively broad tuneable range (several GHz). The previously mentioned alternative solutions (EVCOs with solid state or semiconductor lasers) instead require extreme accuracy in controlling the bias current of the directly modulated semiconductor laser, which is problematic to achieve.
The proposed arrangement of the OVCO enables a nearly ideal frequency translation, whose linearity as a function of applied voltage is limited solely by the linearity of the EVCO and not by the optical components in use. An additional advantage is due to the frequency translation not being affected by any spurious amplitude modulation, thanks to the output signal of the EVCO, whose amplitude is constant throughout its operating range. In the other solutions based on the direct control of the semiconductor laser, the frequency translation is always accompanied by a spurious amplitude modulation which must necessarily be compensated by a dedicated electrical or optical circuit.

The proposed design of the SC-OPLL, based on an EVCO and an external optical modulator, whose combination is equivalent to an OVCO, can be made by exploiting the well known and long-developed theory on electrical PLL; the other solutions, instead, require a specific design based on the peculiarities of the directly modulated laser to be used.
The laser used as a local oscillator is not modulated (Continuous Wave, CW), so it is possible to use an external cavity semiconductor laser, tuneable slowly in wavelength. This solution offers the advantage of having both a fast tuneability over a limited frequency range thanks to the OVCO, and a slow tuneability on a broad range of wavelengths, thanks to the direct control of the parameters available on every commercial tuneable laser. The other solutions, by contrast, require non-commercial laser sources to be developed ad hoc.

Lastly, it is clear that the SC-OPLL and OVCO described and illustrated herein can be subjected to modifications and variations without thereby departing from the scope of the present invention, as defined in the appended claims.

For example, the operating condition whereby the operating point at rest of the Mach-Zehnder modulator 10 should be on a minimum of the electro-optical transfer function F(V) of the modulator is not strictly necessary for the proper operation of the OVCO 4. If said condition were not met and therefore the operating point at rest of the Mach-Zehnder modulator 10 were not on a minimum of the electro-optical transfer function of the modulator, the power spectrum of the output signal of the Mach-Zehnder modulator 10 would contain a spectral line at the frequency F_{LASER} whose amplitude would not be negligible relative to the two spectral lines of interest (sub carrier); this spectral line, however, would anyway be eliminated in the filtering operation carried out by the electrical loop filter 3 and possibly also by the photodetector 7.

Moreover, the polarization controller 5 through which the optical polarizations of the optical signal to be locked and of the locked optical signal are maintained mutually parallel at the input of the photodetector 7, need not necessarily to be positioned at the input of the optical coupler 6 whereon the optical signal to be locked arrives, but may be positioned in any other point of the OPLL 1 in which, in any case, it can operate to maintain parallel the optical polarizations of the optical signal to be locked and of the locked optical signal at the input of the photodetector 7, for example at the output from the optical modulator 10.

Moreover, the optical modulator need not be a Mach-Zehnder modulator, but rather any other type of optical amplitude modulator can be used.

Lastly, since the greater the frequency of the output signal of the EVCO 8, the greater the frequency separation of the spectral lines of the output power spectrum of the optical amplitude modulator 10, the greater the frequency separation of the beats introduced by the photodetection and the better the performance of the OVCO 4, a higher frequency of the output signal of the EVCO 8 could be obtained by translating towards higher frequencies the free oscillation frequency of the EVCO 8 itself.

The translation can be obtained in very simple fashion using a local oscillator with much greater frequency than the free oscillation frequency of the EVCO 8. In particular, by causing the mutual beating between the output signal of the EVCO 8 with free oscillation frequency F_{FO} and the output signal of the local oscillator with frequency F_{LO}, for instance using a simple multiplier, the beat would create two spectral lines respectively at the frequencies F_{LO}−F_{FO} and F_{LO}+F_{FO}. By then filtering away the lower frequency line through an appropriate band pass filter, an electrical signal would thus be obtained with a much greater frequency than that of the EVCO 8, which signal can then be provided as an input to the optical amplitude modulator to modulate the optical carrier provided by the external cavity semiconductor laser.

In addition, the EVCO 8 could be of a different type from the one described above, and in particular, instead of being a voltage controlled electrical oscillator, it could also be a current controlled electrical oscillator. In this latter case, therefore, the OVCO 4 would similarly become a current controlled optical oscillator.

Lastly, the laser source 9 and the optical modulator 10 may be either two separate devices or part of a single optical device.

1. An electrically controlled optical oscillator (4) characterised by:
electrically controlled electrical oscillator means (8) having an input receiving an electrical control signal (VPDF) and an output providing a modulating electrical signal (VEVCO) whose frequency (FEVCO) is correlated to said electrical driving signal (VPDF);
a laser source (9) providing an optical carrier (Soc);
optical amplitude modulator means (10) having an optical input receiving said optical carrier (SoC) and an electrical input receiving said modulating electrical signal (VEVCO) and an optical output providing a modulated optical signal (S2) obtained by amplitude modulating said optical carrier (Soc) with said modulating electrical signal (VEvco).

2. An electrically controlled optical oscillator as claimed in claim 1, wherein said optical amplitude modulator means are a Mach-Zehnder optical amplitude modulator (10).

3. An electrically controlled optical oscillator as claimed in claim 2, wherein the operating point at rest of said Mach-Zehnder modulator (10) is positioned at a minimum of the electro-optical transfer function of the Mach-Zehnder modulator (10) itself.

4. An electrically controlled optical oscillator as claimed in claim 1, wherein said laser source (9) is a continuous wave laser source.

5. An electrically controlled optical oscillator as claimed in claim 1, wherein said laser source (9) is an external cavity semiconductor laser.

6. An electrically controlled optical oscillator as claimed in claim 1, wherein said modulated optical signal (S2) has a power spectrum containing a first subcarrier and a second subcarrier at frequencies correlated to the difference and, respectively, to the sum of the optical frequency (FLASER) of said optical carrier (SOC) and the electrical frequency (FEVCO) of said modulating electrical signal (VEVCO).

7. An electrically controlled optical oscillator as claimed in claim 1, wherein said optical source (9) and said optical amplitude modulator means (10) are part of a single optical device.

8. An optical phase locked loop (1), comprising:
optical phase detector means (2) having a first optical input receiving an optical signal to be locked (sol) and a second optical input receiving a locked optical signal (S2) and an electrical output providing an electrical error signal (VPD) indicating the difference between the phase of said optical signal to be locked (S1) and the phase of said locked optical signal (su);
electrically controlled optical oscillator means (4) having an electrical input receiving an electrical driving signal (VPDF) correlated to said electrical error signal (VPD) and an optical output providing said locked optical signal (S2); characterised in that said electrically controlled optical oscillator means (4) are as claimed in any of the previous claims.

9. An optical phase locked loop as claimed in claim 8, wherein said optical phase detector means (2) comprise:
optical coupler means (6) having a first optical input receiving said optical signal to be locked (S1) and a second optical input receiving said locked optical signal (S2) and an optical output providing a coupled optical signal (S3); and
photodetector means (7) receiving said coupled optical signal and providing said electrical error signal (VPD).

10. An optical phase locked loop as claimed in claim 9, wherein said optical coupler means (6) comprise a 3 dB coupler.

11. An optical phase locked loop as claimed in claim 9, wherein said optical coupler means (6) comprise a hybrid 90° optical coupler.

12. An optical phase locked loop as claimed in claim 8, further comprising:
loop electrical filtering means (3) interposed between said optical phase detector means (2) and said electrically controlled optical oscillator means (4).
